(19) United States
(12) Patent Application Publication
(10) Pub. No.: US 2019/0169426 A1
(43) Pub. Date: Jun. 6, 2019

(54) POLYMER COMPOSITION COMPRISING A THERMOPLASTIC POLYESTER

(71) Applicant: ROQUETTE FRERES, Lestrem (FR)

(72) Inventors: Hélène AMEDRO, BETHUNE (FR); René SAINT-LOUP, LOMME (FR)

(21) Appl. No.: 16/320,813

(22) PCT Filed: Jul. 28, 2017
(86) PCT No.: PCT/FR2017/052144

§ 371 Date: Jan. 25, 2019

(30) Foreign Application Priority Data
Jul. 29, 2016 (FR) 16 57426

(51) Int. Cl. C08L 67/02; B29C 48/00; C08G 63/183

(52) U.S. Cl. CPC C08L 67/02; B29K 2067/003; C08G 63/183; B29C 48/022

(57) ABSTRACT

Polymer composition comprising a thermoplastic polyester having at least one 1,4:3,6-dianhydrohexitol unit (A), at least one alicyclic diol unit (B) other than the 1,4:3,6-dianhydrohexitol units (A), at least one terephthalic acid unit (C), wherein the ratio (A)/[(A)+(B)] is at least 0.05 and at most 0.75, said polyester being free of non-cyclic aliphatic diol units or comprising a molar amount of non-cyclic aliphatic diol units, relative to the totality of monomeric units in the polyester, of less than 5%, and with a reduced viscosity in solution (25° C.; phenol (50 wt. %):ortho-dichlorobenzene (50 wt. %); 5 g/L of polyester) greater than 70 mL/g; as well as an additional polymer selected from aromatic polyesters, aliphatic polyesters, polyester ethers, polyamides, polycarbonates, polyether block amides and polyurethanes.

### FIELD OF THE INVENTION

The present invention relates to a polymer composition comprising an isosorbide-based thermoplastic polyester, said polymer composition having improved properties.

### TECHNICAL BACKGROUND OF THE INVENTION

Plastics have become inescapable in the mass production of objects. Indeed, their thermoplastic nature enables these materials to be transformed at a high rate into all kinds of objects.

For example, certain thermoplastic aromatic polyesters have thermal properties which allow them to be used directly for the production of materials. They comprise aliphatic diol and aromatic diacid units. Among these aromatic polyesters, mention may be made of polyethylene terephthalate (PET), which is a polyester comprising ethylene glycol and terephthalic acid units.

However, for certain applications or under certain usage conditions, it is necessary to improve certain properties, especially impact strength or else heat resistance. This is why glycol-modified PETs (PETgs) have been developed. These are generally polyesters comprising, in addition to the ethylene glycol and terephthalic acid units, cyclohexanedimethanol (CHDM) units. The introduction of this diol into the PET enables it to adapt the properties to the intended application, for example to improve its impact strength or its optical properties, especially when the PETg is amorphous.

Other modified PETs have also been developed by introducing, into the polyester, 1,4:3,6-dianhydrohexitol units, especially isosorbide (PEIT). These modified polyesters have higher glass transition temperatures than the unmodified PETs or PETgs comprising CHDM. In addition, 1,4:3,6-dianhydrohexitols have the advantage of being able to be obtained from renewable resources such as starch.

One drawback with these PEITs is that they may have insufficient impact strength properties. In addition, the glass transition temperature may be insufficient for the production of certain plastic objects.

In order to improve the impact strength properties of the polyesters, it is known from the prior art to use polyesters in which the crystallinity has been reduced. As regards isosorbide-based polyesters, mention may be made of application US2012/0177854, which describes polyesters comprising terephthalic acid units and diol units comprising from 1 to 60 mol % of isosorbide and from 5 to 99% of 1,4-cyclohexanedimethanol which have improved impact strength properties.

As indicated in the introductory section of this application, the aim is to obtain polymers in which the crystallinity is eliminated by the addition of comonomers, and hence in this case by the addition of 1,4-cyclohexanedimethanol. In the examples section, the production of various poly(ethylene-co-1,4-cyclohexanedimethylene-co-isosorbide)terephthalates (PECITs), and also an example of poly(1,4-cyclohexanedimethylene-co-isosorbide)terephthalate (PCIT), are described.

It may also be noted that while polymers of PECIT type have been the subject of commercial developments, this is not the case for PCITs. Indeed, their production was hitherto considered to be complex, since isosorbide has low reactivity as a secondary diol. Yoon et al. (Synthesis and Characteristics of a Biobased High-Tg Terpolyester of Isosorbide, Ethylene Glycol, and 1,4-Cyclohexane Dimethanol: Effect of Ethylene Glycol as a Chain Linker on Polymerization, Macromolecules, 2013, 46, 7219-7231) thus showed that the synthesis of PCIT is much more difficult to achieve than that of PECIT. This paper describes the study of the influence of the ethylene glycol content on the PECIT production kinetics.

In Yoon et al., an amorphous PCIT (which comprises approximately 29% of isosorbide and 71% of CHDM, relative to the sum of the diols) is produced to compare its synthesis and its properties with those of PECIT-type polymers. The use of high temperatures during the synthesis induces thermal degradation of the polymer formed if reference is made to the first paragraph of the Synthesis section on page 7222, this degradation especially being linked to the presence of aliphatic cyclic diols such as isosorbide. Therefore, Yoon et al. used a process in which the polycondensation temperature is limited to 270° C. Yoon et al. observed that, even increasing the polymerization time, the process also does not make it possible to obtain a polyester having a sufficient viscosity. Thus, without addition of ethylene glycol, the viscosity of the polyester remains limited, this being despite the use of prolonged synthesis times.

In the plastics field, there is a constant need to have available new solutions, in particular based on isosorbide, for producing or obtaining objects with improved characteristics.

In order to achieve this objective, it is known practice to blend polymers together in order to obtain compositions which have improved properties that make it possible to have more widespread fields of application and use.

U.S. Pat. No. 6,140,422 describes a blend of isosorbide-based polyesters and of other thermoplastic polymers. The isosorbide-based polyester includes terephthalic acid units and ethylene glycol units and has a viscosity of at least 0.35 dl/g. The blending of the polyester can be carried out with thermoplastic polymers such as styrene resins, polyaryl ethers or else polyhydroxy ethers. Generally, the improvement in the properties of a polymer blend involves good physical or chemical compatibility; in this case, when the polyester is blended with the thermoplastic polymer, a transesterification reaction may occur as a function of the polymers selected and it may be particularly advantageous for this reaction to take place in a wet medium in order to facilitate this reaction. However, not all the thermoplastic polymers used in this patent can perform transesterification in a wet medium when they are blended with isosorbide-based polyesters.

There is still a need for isosorbide-based polymer compositions which make it possible to obtain plastic objects with improved properties, and also still a need to develop isosorbide-based polyesters for improving the properties of existing polymers in order to obtain, after blending, polymer compositions with improved properties.

However, it is not sufficient to blend two polymers so as to obtain an advantageous polymer composition with unprecedented properties. Indeed, other than for a few exceptions, it is not possible to blend two polymers on the molecular scale. Said polymers inevitably separate into domains of macroscopic size, separated by weak interfaces. The material resulting from the polymer composition obtained is generally poorer than the starting polymers taken separately.

It is therefore to the applicant's credit to have found that this objective can be achieved, against all expectations, with an isosorbide-based thermoplastic polyester which does not have any ethylene glycol, although it was known up until now that the latter was essential for the incorporation of said isosorbide by performing a relevant selection on the thermoplastic polymers used in the blend and by employing a process capable of promoting transesterification (presence of moisture in the starting polymer blend).

The polymer compositions obtained from the blend of these thermoplastic polyesters with other polymers thus make it possible to obtain objects with improved technical characteristics.

### SUMMARY OF THE INVENTION

A first subject of the invention relates to a polymer composition comprising:
a thermoplastic polyester comprising at least one 1,4:3,6-dianhydrohexitol unit (A), at least one alicyclic diol unit (B) other than the 1,4:3,6-dianhydrohexitol units (A), at least one terephthalic acid unit (C), wherein the (A)/[(A)+(B)] ratio is at least 0.05 and at most 0.75, said polyester not containing any aliphatic non-cyclic diol units or comprising a molar amount of aliphatic non-cyclic diol units, relative to all the monomer units of the polyester, of less than 5%, and the reduced solution viscosity (25° C.; phenol (50% m):ortho-dichlorobenzene (50% m); 5 g/l of polyester) of said polyester is greater than 70 ml/g;
a polymer chosen from aromatic polyesters, aliphatic polyesters, polyester ethers, polyamides, polycarbonates, polyether block amide, polyurethanes and isocyanate-free polyurethanes.

A second subject of the invention relates to a process for improving the physical and chemical properties of a specific polymer as previously defined.

The polymer composition according to the invention is particularly advantageous and has improved properties. Indeed, the presence of the thermoplastic polyester in the composition makes it possible to introduce additional properties and to broaden the fields of application of other polymers.

### DETAILED DESCRIPTION OF THE INVENTION

A first subject of the invention thus relates to a polymer composition comprising:
a thermoplastic polyester comprising at least one 1,4:3,6-dianhydrohexitol unit (A), at least one alicyclic diol unit (B) other than the 1,4:3,6-dianhydrohexitol units (A), at least one terephthalic acid unit (C), wherein the (A)/[(A)+(B)] ratio is at least 0.05 and at most 0.75, said polyester not containing any aliphatic non-cyclic diol units or comprising a molar amount of aliphatic non-cyclic diol units, relative to all the monomer units of the polyester, of less than 5%, and the reduced solution viscosity (25° C.; phenol (50% m):ortho-dichlorobenzene (50% m); 5 g/l of polyester) of said polyester is greater than 70 ml/g;
a polymer chosen from aromatic polyesters, aliphatic polyesters, polyester ethers, polyamides, polycarbonates, polyether block amide, polyurethanes and polyurethanes.

“(A)/[(A)+(B)] molar ratio” is intended to mean the molar ratio of 1,4:3,6-dianhydrohexitol units (A)/sum of 1,4:3,6-dianhydrohexitol units (A) and alicyclic diol units (B) other than the 1,4:3,6-dianhydrohexitol units (A).

The thermoplastic polyester does not contain any aliphatic non-cyclic diol units, or comprises a small amount thereof.

“Small molar amount of aliphatic non-cyclic diol units” is intended to mean, especially, a molar amount of aliphatic non-cyclic diol units of less than 5%. According to the invention, this molar amount represents the ratio of the sum of the aliphatic non-cyclic diol units, these units possibly being identical or different, relative to all the monomer units of the polyester.

An aliphatic non-cyclic diol may be a linear or branched aliphatic non-cyclic diol. It may also be a saturated or unsaturated aliphatic non-cyclic diol. Aside from ethylene glycol, the saturated linear aliphatic non-cyclic diol may for example be 1,3-propanediol, 1,4-butanediol, 1,5-pentanediol, 1,6-hexanediol, 1,8-octanediol and/or 1,10-decanediol. As examples of saturated branched aliphatic non-cyclic diol, mention may be made of 2-methyl-1,3-propanediol, 2,2,4-trimethyl-1,3-pentanediol, 2-ethyl-2-butyl-1,3-propanediol, propylene glycol and/or neopentyl glycol. As an example of an unsaturated aliphatic diol, mention may be made, for example, of cis-2-butene-1,4-diol.

This molar amount of aliphatic non-cyclic dial unit is advantageously less than 1%. Preferably, the polyester is free of any aliphatic non-cyclic diol units and more preferentially it is free of ethylene glycol.

Despite the low amount of aliphatic non-cyclic diol, and hence of ethylene glycol, used for the synthesis, a thermoplastic polyester is surprisingly obtained which has a high reduced solution viscosity and in which the isosorbide is particularly well incorporated. Without being bound by any one theory, this would be explained by the fact that the reaction kinetics of ethylene glycol are much faster than those of 1,4:3,6-dianhydrohexitol, which greatly limits the integration of the latter into the polyester. The polyesters resulting therefrom thus have a low degree of integration of 1,4:3,6-dianhydrohexitol and consequently a relatively low glass transition temperature.

The monomer (A) is a 1,4:3,6-dianhydrohexitol and may be isosorbide, isomannide, isoidide, or a mixture thereof. Preferably, the 1,4:3,6-dianhydrohexitol (A) is isosorbide. Isosorbide, isomannide and isoidide may be obtained, respectively, by dehydration of sorbitol, of mannitol and of iditol. As regards isosorbide, it is sold by the applicant under the brand name Polysorb® P.

The alicyclic diol (B) is also referred to as aliphatic and cyclic diol. It is a diol which may especially be chosen from 1,4-cyclohexanedimethanol, 1,2-cyclohexanedimethanol, 1,3-cyclohexanedimethanol or a mixture of these diols. The alicyclic diol (B) is very preferentially 1,4-cyclohexanedimethanol. The alicyclic diol (B) may be in the cis configuration, in the trans configuration, or may be a mixture of diols in the cis and trans configurations.

The molar ratio of 1,4:3,6-dianhydrohexitol units (A)/sum of 1,4:3,6-dianhydrohexitol units (A) and alicyclic diol units (B) other than the 1,4:3,6-dianhydrohexitol units (A), i.e. (A)/[(A)+(B)], is at least 0.05 and at most 0.75. Advantageously, this ratio is at least 0.10 and at most 0.65.

A thermoplastic polyester that is particularly suitable for obtaining the polymer composition comprises:
a molar amount of 1,4:3,6-dianhydrohexitol units (A) ranging from 2.5 to 54 mol %;
a molar amount of alicyclic diol units (B) other than the 1,4:3,6-dianhydrohexitol units (A) ranging from 5 to 42.5 mol %;
a molar amount of terephthalic acid units (C) ranging from 45 to 55 mol %.

Depending on the desired application using the polymer composition, the thermoplastic polyester may be a semicrystalline thermoplastic polyester and thus comprises:
a molar amount of 1,4:3,6-dianhydrohexitol units (A) ranging from 2.5 to 14 mol %;
a molar amount of alicyclic diol units (B) other than the 1,4:3,6-dianhydrohexitol units (A) ranging from 31 to 42.5 mol %;
a molar amount of terephthalic acid units (C) ranging from 45 to 55 mol %.

However, for other applications, the thermoplastic polyester may be an amorphous thermoplastic polyester and thus comprises:
a molar amount of 1,4:3,6-dianhydrohexitol units (A) ranging from 16 to 54 mol %;
a molar amount of alicyclic diol units (B) other than the 1,4:3,6-dianhydrohexitol units (A) ranging from 5 to 30 mol %;
a molar amount of terephthalic acid units (C) ranging from 45 to 55 mol %.

Those skilled in the art will thus know how to adjust the molar amounts of different units and to verify the semicrystalline or amorphous appearance of the polyester obtained, in particular by detecting X-ray diffraction lines or by the presence of an endothermic melting peak in differential scanning calorimetry (DSC) analysis.

The amounts of different units in the polyester may be determined by ¹H NMR or by chromatographic analysis of the mixture of monomers resulting from complete hydrolysis or methanolysis of the polyester, preferably by ¹H NMR.

Those skilled in the art can readily find the analysis conditions for determining the amounts of each of the units of the polyester. For example, from an NMR spectrum of a poly(1,4-cyclohexanedimethylene-co-isosorbide terephthalate), the chemical shifts relating to the 1,4-cyclohexanedimethanol are between 0.9 and 2.4 ppm and 4.0 and 4.5 ppm, the chemical shifts relating to the terephthalate ring are between 7.8 and 8.4 ppm and the chemical shifts relating to the isosorbide are between 4.1 and 5.8 ppm. The integration of each signal makes it possible to determine the amount of each unit of the polyester.

The thermoplastic polyesters have a glass transition temperature ranging from 85 to 200° C., for example from 90 to 115° C. if they are semicrystalline, and for example from 116° C. to 200° C. if they are amorphous.

The glass transition temperatures and melting points are measured by conventional methods, especially using differential scanning calorimetry (DSC) using a heating rate of 10° C./min. The experimental protocol is described in detail in the examples section below.

The thermoplastic polyesters used according to the invention, when they are semicrystalline, have a melting point ranging from 210 to 295° C., for example from 240 to 285° C.

Advantageously, when the thermoplastic polyester is semicrystalline, it has a heat of fusion of greater than 10 J/g, preferably greater than 20 J/g, the measurement of this heat of fusion consisting in subjecting a sample of this polyester to a heat treatment at 170° C. for 16 hours, then in evaluating the heat of fusion by DSC by heating the sample at 10° C./min.

The thermoplastic polyester of the polymer composition according to the invention has in particular a lightness L* greater than 40. Advantageously, the lightness L* is greater than 55, preferably greater than 60, most preferentially greater than 65, for example greater than 70. The parameter L* may be determined using a spectrophotometer, via the CIE Lab model.

Finally, the reduced solution viscosity of said thermoplastic polyester according to the invention is greater than 70 ml/g and preferably less than 150 ml/g, this viscosity being able to be measured using an Ubbelohde capillary viscometer at 25° C. in an equi-mass mixture of phenol and ortho-dichlorobenzene after dissolving the polymer at 130° C. with stirring, the concentration of polymer introduced being 5 g/I.

This test for measuring reduced solution viscosity is, due to the choice of solvents and the concentration of the polymers used, perfectly suited to determining the viscosity of the viscous polymer prepared according to the process described below.

The semicrystalline or amorphous nature of the thermoplastic polyesters used according to the present invention is characterized, after a heat treatment of 16 h at 170° C., by the presence or absence of X-ray diffraction lines or of an endothermic melting peak in differential scanning calorimetry (DSC) analysis. Thus, when X-ray diffraction lines are present and an endothermic melting peak is present in differential scanning calorimetry (DSC) analysis, the thermoplastic polyester is semicrystalline, and if they are absent, it is amorphous.

The thermoplastic polyester as previously defined has many advantages within the polymer composition.

Indeed, by virtue in particular of the molar ratio of 1,4:3,6-dianhydrohexitol units (A)/sum of 1,4:3,6-dianhydrohexitol units (A) and alicyclic diol units (B) other than the 1,4:3,6-dianhydrohexitol units (A) of at least 0.05 and of at most 0.75 and of a reduced solution viscosity of greater than 70 ml/g and preferably less than 150 ml/g, the thermoplastic polyesters make it possible to obtain polymer compositions with improved properties which make it possible to have more widespread fields of application and use.

In addition to a thermoplastic polyester, the composition according to the invention comprises another polymer, hereinafter referred to as additional polymer.

According to the invention, the additional polymer is chosen from:
aromatic polyesters such as, for example, poly(trimethylene terephthalate) (PTT), polyethylene terephthalate (PET), polybutylene terephthalate (PBT), polyethylene naphthalate (PEN) or else polybutylene naphthalate (PBN);
aliphatic polyesters such as, for example, polybutylene succinate (PBS), polylactic acid (PLA), polybutylene succinate-co-adipate (PBSA), polybutylene adipate, polyethylene azelate or else polybutylene sebacate;
polyester ethers such as, for example, the thermoplastic elastomer Hytrel® (poly(butylene terephthalate)-block-poly(butyl ether));
polyamides such as, for example, the semi-aromatic polyamide mXD6, poly(p-phenyleneterephthalamide) (PA PPD-T) or else poly(m-phenyleneisophthalamide) (MPD-I);
polycarbonates;
polyether block amides;
polyurethanes with or without isocyanate.

Preferentially, the additional polymer is a polyester ether or a polyamide and even more preferentially mXD6 or a thermoplastic elastomer such as, for example, Hytrel®.

The polymer composition according to the invention can be obtained according to the conventional methods known to those skilled in the art for blending polymers. For example, the blend can be obtained using internal mixers or blenders, or using customary systems for forming thermoplastic polymers, such as extrusion or coextrusion instruments.

Furthermore, the polymer composition can be obtained directly by melt blending after polymerization of the thermoplastic polyester and of the polymer.

Once obtained, the polymer composition may be formed according to the intended applications.

According to one alternative, the thermoplastic polyester and the additional polymer may be packaged, before being blended, in an easily handleable form such as pellets or granules. Preferentially, the thermoplastic polyester and the polymer are packaged in the form of granules. Thus, the polymer composition according to the invention may for example be obtained by extrusion or coextrusion of the various granules.

The polymer composition according to the invention is thus obtained by blending between a thermoplastic polyester and an additional polymer. The blend has the particularity of being produced without drying, in other words the thermoplastic polyester and the additional polymer do not need to be dried before being blended, for example by extrusion. Preferentially, the residual moisture content before the blending step is greater than 150 ppm, preferably greater than 200 ppm and more preferably greater than 300 ppm.

Thus, among the chemical reactions that can occur during the blending, the transesterification reactions are promoted.

The blending of the thermoplastic polyesters according to the invention with an additional polymer makes it possible to obtain compositions for which the use ranges are potentiated compared with the additional polymers alone.

For example, the blending of a polyester according to the invention with a polyester ether makes it possible to obtain a polymer composition which has a higher melting point compared with the polyester ethers alone.

Another example may be given by the blending of a thermoplastic polyester according to the invention with a polyimide. The polymer composition thus obtained exhibits in particular, when it is made into the form of a film, an improved gas permeability.

According to one particular embodiment, the polymer composition also comprises a compatibilizing agent which makes it possible to potentiate the esterification reactions by acting as a catalyst. Such examples of agents are in particular polyfunctional alcohols and acids. For example, the compatibilizing agent may be titanium tetrabutoxide.

One or more additives may also be added during the obtaining of the polymer composition from the thermoplastic polyester in order to give it particular properties.

Thus, by way of examples of additives, mention may be made of fillers or fibers of organic or mineral, nanometric or non-nanometric, functionalized or non-functionalized nature. They may be silicas, zeolites, glass fibers or beads, clays, mica, titanates, silicates, graphite, calcium carbonate, carbon nanotubes, wood fibers, carbon fibers, polymer fibers, proteins, cellulose-based fibers, lignocellulosic fibers and non-destructured granular starch. These fillers or fibers can make it possible to improve the hardness, the rigidity or the water- or gas-permeability.

The additive may also be chosen from opacifiers, dyes and pigments. They may be chosen from cobalt acetate and the following compounds: HS-325 Sandoplast® Red BB (which is a compound bearing an azo function, also known under the name Solvent Red 195), HS-510 Sandoplast® Blue 2B which is an anthraquinone, Polysynthren® Blue R, and Clariant® RSB Violet.

The additive may also be a UV-resistance agent such as, for example, molecules of benzophenone or benzotriazole type, such as the Tinuvin™ range from BASF: tinuvin 326, tinuvin P or tinuvin 234, for example, or hindered amines such as the Chimassorb™ range from BASF: Chimassorb 2020, Chimasorb 81 or Chimassorb 944, for example.

The additive may also be a fire-proofing agent or flame retardant, such as, for example, halogenated derivatives or non-halogenated flame retardants (for example phosphorus-based derivatives such as Exolit® OP) or such as the range of melamine cyanurates (for example Melapur™: melapur 200), or else aluminum or magnesium hydroxides.

Finally, the additive may also be an antistatic agent or else an anti-block agent, such as derivatives of hydrophobic molecules, for example Incroslip™ or Incromol™ from Croda.

Depending on the desired applications, the polymer composition can be formed according to the techniques known to those skilled in the art and will thus be able to have a multitude of aspects, for instance a film.

Advantageously and by virtue of its particular properties, the polymer composition according to the invention has a most particular application for the production of plastic objects or elements.

A second subject of the invention relates to a process for improving the physical or chemical properties of polymers.

The process according to the invention makes it possible to improve the mechanical or physical properties of certain polymers by blending them with a thermoplastic polyester.

The process according to the invention thus comprises the following steps of:
provision of a polymer chosen from aromatic polyesters, aliphatic polyesters, polyester ethers, polyamides, polycarbonates, polyether block amides and polyurethanes,
blending of said polymer with a thermoplastic polyester as previously defined,
recovery of said blend.

The blending step can be carried out according to techniques known to those skilled in the art. For example, the blending can be carried out by extrusion or coextrusion techniques.

The process according to the invention thus makes it possible to improve the mechanical and/or physical properties of the polymer provided.

The thermoplastic polyester that is particularly suitable for the obtaining of the polymer composition can be prepared by means of a synthesis process comprising:
a step of introducing, into a reactor, monomers comprising at least one 1,4:3,6-dianhydrohexitol (A), at least one alicyclic diol (B) other than the 1,4:3,6-dianhydrohexitols (A) and at least one terephthalic acid (C), the molar ratio ((A)+(B))/(C) ranging from 1.05 to 1.5, said monomers not containing any aliphatic non-cyclic diols or comprising, relative to all of the monomers introduced, a molar amount of aliphatic non-cyclic diol units of less than 5%;
a step of introducing, into the reactor, a catalytic system;
a step of polymerizing said monomers to form the polyester, said step consisting of:
   a first stage of oligomerization, during which the reaction medium is stirred under an inert atmosphere at a temperature ranging from 265 to 280° C., advantageously from 270 to 280° C., for example 275° C.;
   a second stage of condensation of the oligomers, during which the oligomers formed are stirred under vacuum, at a temperature ranging from 278 to 300° C. so as to form the polyester, advantageously from 280 to 290° C., for example 285° C.;
a step of recovering the thermoplastic polyester.

This first stage of the process is carried out in an inert atmosphere, that is to say under an atmosphere of at least one inert gas. This inert gas may especially be dinitrogen. This first stage may be carried out under a gas stream and it may also be carried out under pressure, for example at a pressure of between 1.05 and 8 bar.

Preferably, the pressure ranges from 3 to 8 bar, most preferentially from 5 to 7.5 bar, for example 6.6 bar. Under these preferred pressure conditions, the reaction of all the monomers with one another is promoted by limiting the loss of monomers during this stage.

Prior to the first stage of oligomerization, a step of deoxygenation of the monomers is preferentially carried out. It can be carried out for example once the monomers have been introduced into the reactor, by creating a vacuum then by introducing an inert gas such as nitrogen thereto. This vacuum-inert gas introduction cycle can be repeated several times, for example from 3 to 5 times. Preferably, this vacuum-nitrogen cycle is carried out at a temperature of between 60 and 80° C. so that the reagents, and especially the diols, are totally molten. This deoxygenation step has the advantage of improving the coloration properties of the polyester obtained at the end of the process.

The second stage of condensation of the oligomers is carried out under vacuum. The pressure may decrease continuously during this second stage by using pressure decrease ramps, in steps, or else using a combination of pressure decrease ramps and steps. Preferably, at the end of this second stage, the pressure is less than 10 mbar, most preferentially less than 1 mbar.

The first stage of the polymerization step preferably has a duration ranging from 20 minutes to 5 hours. Advantageously, the second stage has a duration ranging from 30 minutes to 6 hours, the beginning of this stage consisting of the moment at which the reactor is placed under vacuum, that is to say at a pressure of less than 1 bar.

The process also comprises a step of introducing a catalytic system into the reactor. This step may take place beforehand or during the polymerization step described above.

Catalytic system is intended to mean a catalyst or a mixture of catalysts, optionally dispersed or fixed on an inert support.

The catalyst is used in amounts suitable for obtaining a high-viscosity polymer for the obtaining of the polymer composition.

An esterification catalyst is advantageously used during the oligomerization stage. This esterification catalyst can be chosen from derivatives of tin, titanium, zirconium, hafnium, zinc, manganese, calcium and strontium, organic catalysts such as para-toluenesulfonic acid (PTSA) or methanesulfonic acid (MSA), or a mixture of these catalysts. By way of example of such compounds, mention may be made of those given in application US 2011282020A1 in paragraphs [0026] to [0029], and on page 5 of application WO 2013/062408 A1.

Preferably, a zinc derivative or a manganese, tin or germanium derivative is used during the first stage of transesterification.

By way of example of amounts by weight, use may be made of from 10 to 500 ppm of metal contained in the catalytic system during the oligomerization stage, relative to the amount of monomers introduced.

At the end of transesterification, the catalyst from the first step can be optionally blocked by adding phosphorous acid or phosphoric acid, or else, as in the case of tin(IV), reduced with phosphites such as triphenyl phosphite or tris(nonylphenyl) phosphites or those cited in paragraph [0034] of application US 2011282020A1.

The second stage of condensation of the oligomers may optionally be carried out with the addition of a catalyst. This catalyst is advantageously chosen from tin derivatives, preferentially derivatives of tin, titanium, zirconium, germanium, antimony, bismuth, hafnium, magnesium, cerium, zinc, cobalt, iron, manganese, calcium, strontium, sodium, potassium, aluminum or lithium, or of a mixture of these catalysts. Examples of such compounds may for example be those given in patent EP 1 882 712 BI in paragraphs [0090] to [0094].

Preferably, the catalyst is a tin, titanium, germanium, aluminum or antimony derivative. By way of example of amounts by weight, use may be made of from 10 to 500 ppm of metal contained in the catalytic system during the stage of condensation of the oligomers, relative to the amount of monomers introduced.

Most preferentially, a catalytic system is used during the first stage and the second stage of polymerization. Said system advantageously consists of a catalyst based on tin or of a mixture of catalysts based on tin, titanium, germanium and aluminum.

By way of example, use may be made of an amount by weight of 10 to 500 ppm of metal contained in the catalytic system, relative to the amount of monomers introduced.

According to the preparation process, an antioxidant is advantageously used during the step of polymerization of the monomers. These antioxidants make it possible to reduce the coloration of the polyester obtained. The antioxidants may be primary and/or secondary antioxidants. The primary antioxidant may be a sterically hindered phenol, such as the compounds Hostanox® 0 3, Hostanox® 0 10, Hostanox® 0 16, Ultranox® 210, Ultranox® 276, Dovernox® 10, Dovernox® 76, Dovernox® 3114, Irganox® 1010 or Irganox® 1076 or a phosphonate such as Irgamod® 195. The secondary antioxidant may be trivalent phosphorus compounds such as Ultranox® 626, Doverphos® S-9228, Hostanox® P-EPQ or Irgafos 168.

It is also possible to introduce as polymerization additive into the reactor at least one compound that is capable of limiting unwanted etherification reactions, such as sodium acetate, tetramethylammonium hydroxide or tetraethylammonium hydroxide.

Finally, the process comprises a step of recovering the polyester resulting from the polymerization step. The thermoplastic polyester thus recovered can then be formed as described above.

According to one variant of the synthesis process, when the polyester is semicrystalline, a step of increasing the molar mass can be carried out after the step of recovering the thermoplastic polyester.

The step of increasing the molar mass is carried out by post-polymerization and may consist of a step of solid-state polycondensation (SSP) of the semicrystalline thermoplastic polyester or of a step of reactive extrusion of the semicrystalline thermoplastic polyester in the presence of at least one chain extender.

Thus, according to a first variant of the production process, the post-polymerization step is carried out by SSP.

SSP is generally carried out at a temperature between the glass transition temperature and the melting point of the polymer. Thus, in order to carry out the SSP, it is necessary for the polymer to be semicrystalline. Preferably, the latter has a heat of fusion of greater than 10 J/g, preferably greater than 20 J/g, the measurement of this heat of fusion consisting in subjecting a sample of this polymer of lower reduced solution viscosity to a heat treatment at 170° C. for 16 hours, then in evaluating the heat of fusion by DSC by heating the sample at 10 K/min.

Advantageously, the SSP step is carried out at a temperature ranging from 190 to 280° C., preferably ranging from 200 to 250° C., this step imperatively having to be carried out at a temperature below the melting point of the semicrystalline thermoplastic polyester.

The SSP step may be carried out in an inert atmosphere, for example under nitrogen or under argon or under vacuum.

According to a second variant of the production process, the post-polymerization step is carried out by reactive extrusion of the semicrystalline thermoplastic polyester in the presence of at least one chain extender.

The chain extender is a compound comprising two functions capable of reacting, in reactive extrusion, with alcohol, carboxylic acid and/or carboxylic acid ester functions of the semicrystalline thermoplastic polyester. The chain extender may, for example, be chosen from compounds comprising two isocyanate, isocyanurate, lactam, lactone, carbonate, epoxy, oxazoline and imide functions, it being possible for said functions to be identical or different. The chain extension of the thermoplastic polyester may be carried out in any of the reactors capable of mixing a very viscous medium with stirring that is sufficiently dispersive to ensure a good interface between the molten material and the gaseous headspace of the reactor. A reactor that is particularly suitable for this treatment step is extrusion.

The reactive extrusion may be carried out in an extruder of any type, especially a single-screw extruder, a co-rotating twin-screw extruder or a counter-rotating twin-screw extruder. However, it is preferred to carry out this reactive extrusion using a co-rotating extruder.

The reactive extrusion step may be carried out by:
introducing the polymer into the extruder so as to melt said polymer;
then introducing the chain extender into the molten polymer;
then reacting the polymer with the chain extender in the extruder;
then recovering the semicrystalline thermoplastic polyester obtained in the extrusion step.

During the extrusion, the temperature inside the extruder is adjusted so as to be above the melting point of the polymer. The temperature inside the extruder may range from 150 to 320° C.

The semicrystalline thermoplastic polyester obtained after the step of increasing the molar mass is recovered and then formed as previously described.

The invention will be understood more clearly by means of the examples and figures below, which are intended to be purely illustrative and do not in any way limit the scope of the protection.

### EXAMPLES

The properties of the polymers were studied via the following techniques:

Reduced Solution Viscosity

The reduced solution viscosity is evaluated using an Ubbelohde capillary viscometer at 25° C. in an equi-mass mixture of phenol and ortho-dichlorobenzene after dissolving the polymer at 130° C. with stirring, the concentration of the polymer introduced being 5 g/I.

DSC

The thermal properties of the polyesters were measured by differential scanning calorimetry (DSC): the sample is first heated under a nitrogen atmosphere in an open crucible from 10 to 320° C. (10° C.min⁻¹), cooled to 10° C. (10° C.min⁻¹), then heated again to 320° C. under the same conditions as the first step. The glass transition temperatures were taken at the mid-point of the second heating. Any melting points are determined on the endothermic peak (onset) at the first heating.

Similarly, the enthalpy of fusion (area under the curve) is determined at the first heating.

For the Illustrative Examples Presented Below, the Following Reagents were Used:
1,4-Cyclohexanedimethanol (99% purity, mixture of cis and trans isomers)
Isosorbide (purity >99.5%) Polysorb® P from Roquette Frères
Terephthalic acid (99+% purity) from Acros
Irganox® 1010 from BASF AG
Dibutyltin oxide (98% purity) from Sigma Aldrich
Hytrel®: Hytrel 5556 from Dupont
mXD6: grade S6007 from Mitsubishi Gaz Chemical

### Example 1: Polymer Composition Comprising a Thermoplastic Polyester and a Polyester Ether

A: Polymerization of a thermoplastic polyester P1

1432 g (9.9 mol) of 1,4-cyclohexanedimethanol, 484 g (3.3 mol) of isosorbide, 2000 g (12.0 mol) of terephthalic acid, 1.65 g of Irganox 1010 (antioxidant) and 1.39 g of dibutyltin oxide (catalyst) are added to a 7.5 l reactor. To extract the residual oxygen from the isosorbide crystals, 4 vacuum-nitrogen cycles are carried out once the temperature of the reaction medium is 60° C.

The reaction mixture is then heated to 275° C. (4° C./min) under 6.6 bar of pressure and with constant stirring (150 rpm) until a degree of esterification of 87% is obtained (estimated from the mass of distillate collected). The pressure is then reduced to 0.7 mbar over the course of 90 minutes according to a logarithmic gradient and the temperature is brought to 285° C.

These vacuum and temperature conditions were maintained until an increase in torque of 12.1 Nm relative to the initial torque is obtained.

Finally, a polymer rod is cast via the bottom valve of the reactor, cooled to 15° C. in a heat-regulated water bath and chopped into the form of granules G1 of about 15 mg.

The granules G1 are then used in a solid-state post-condensation step.

Thus, the granules G1 are crystallized for 2 h in an oven under vacuum at 170° C.

A solid-state post-condensation step was carried out on 10 kg of these granules for 20 h at 210° C. under a stream of nitrogen (1500 I/h) in order to increase the molar mass. The resin after solid-state condensation has a reduced solution viscosity of 103.4 ml·g⁻¹.

The ¹H NMR analysis of the polyester shows that the polyester P1 contains 17.0 mol % of isosorbide relative to the diols.

With regard to the thermal properties, the polyester P1 has a glass transition temperature of 96° C., a melting point of 253° C. with an enthalpy of fusion of 23.2 J/g.

B: Extrusion for the Blending

A “dry” blend containing 70% by weight of polyester P1 (residual moisture content 0.1%) and 10% by weight of the Hytrel® polyester ether is introduced into a TSA extruder that has a diameter of 26 with an L/D ratio of 40 with 8 heating zones.

The total granule flow rate is fixed at 5 kg/h and the heating zones are regulated at the temperatures as described in table 1 below:

TABLE 1

| | | | | | Zone | | Zone |
|---|---|---|---|---|---|---|---|
| Zone 1 | Zone 2 | Zone 3 | Zone 4 | Zone 5 | 6 | Zone 7 | 8 |
| Ambient | 260 | 280 | 290 | 290 | 290 | 280 | 275 |
| T | | | | | | | |

The rod extruded at the extruder outlet is cut up to form granules G1′ of 20 to 25 mg each.

These granules G1′ are vacuum-dried at 150° C. before being injected. The residual moisture content in the granules G1′ is 125 ppm.

C: Injection for Forming

An injection is carried out on an Engel Victory 80 press.

The granules G1′ obtained in the extrusion step are kept in a dry atmosphere and introduced into the hopper of the injection press with the following temperatures (4 heating zones, nozzle->feed): 275/275/260/260, the mold temperature is fixed at 50° C. The granules are injected in the form of bars (or test specimens) 4 mm thick.

The parameters used for the injection are presented in table 2 below:

TABLE 2

| Parameters | Units | Values |
|---|---|---|
| Introduction zone temperature | ° C. | 220 |
| Temperature of the molten plastic | ° C. | 275/275/260/260 |
| (nozzle/tube) | | |
| Mold temperature | ° C. | 50 |
| Injection speed | mm/s | 80 |
| Holding pressure | bar | 29 |
| Holding time | s | 15 |
| Cooling time | s | 15 |

Test specimens are thus obtained.

The dynamic thermomechanical analysis shows an alpha 1 transition temperature (Tα1) at low temperature (−55° C.) and also an alpha 2 transition temperature (Tα2) at 85° C.

The DSC analysis shows a melting point at 285° C. and also the glass transition temperature Tg associated with Tα1 at −55° C.

The Tg associated with Tα2 does not appear on the thermograms.

The polymer composition corresponds, in this example, to the definition of a thermoplastic elastomer and has a broadened use range compared with that of Hytrel®. Indeed, the melting point Mp is measured at 258° C. instead of 222° C. for Hytrel® alone.

### Example 2: Polymer Composition Comprising a Thermoplastic Polyester and a Polyamide

A: Polymerization

The polymerization is carried out according to the same procedure, the same amounts and the same compounds as example 1.

B: Extrusion for the Blending

A “dry” blend is prepared with 80% by weight of polyester P1 obtained in the polymerization step (residual moisture content 0.1%), 20% by weight of polyamide mXD6, and an added 0.1% of titanium tetrabutoxide as compatibilizing agent, which makes it possible to catalyze the transesteramidation reaction. The blend is then introduced into a TSA extruder that has a diameter of 26 with an L/D ratio of 40 with 8 heating zones.

The total granule flow rate is fixed at 5 kg/h and the heating zones are regulated at the temperatures as described in table 3 below:

TABLE 3

| | | | | | Zone | | Zone |
|---|---|---|---|---|---|---|---|
| Zone 1 | Zone 2 | Zone 3 | Zone 4 | Zone 5 | 6 | Zone 7 | 8 |
| Ambient | 260 | 280 | 290 | 290 | 290 | 280 | 275 |
| T | | | | | | | |

The rod extruded at the extruder outlet is cut up to form granules G2 of 20 to 25 mg each.

C: Extrusion for Forming

The granules G2 obtained in the extrusion step B are vacuum-dried at 140° C. in order to achieve residual moisture contents of less than 300 ppm; in this example, the water content of the granules is 148 ppm.

The granules, kept in a dry atmosphere, are then introduced into the hopper of the extruder.

The extruder used is a Collin extruder fitted with a flat die, the assembly being completed by a calendering machine. The extrusion parameters are collated in table 4 below:

TABLE 4

| Parameters | Units | Values |
|---|---|---|
| Temperature (feed −> die) | ° C. | 280/285/285/290/295 |
| Screw rotation speed | rpm | 80 |
| Temperature of the rollers | ° C. | 40 |

The sheets thus extruded from the polyester have a thickness of 4 mm.

The sheets are then cut up into squares 11.2×11.2 cm in size and then, using a Bruckner Karo IV stretching machine, the cut pieces of the sheets are stretched in two directions, this being carried out at a temperature of from 130° C. to 140° C. with a stretch ratio of 2.8×2.8 and for a time of 2 seconds in the two directions.

A biaxially oriented film with a thickness of 14 μm is thus obtained after this treatment.

The films obtained from the polymer composition according to the invention have increased properties with respect to gas permeability compared with films obtained with the polyester alone.

1. A polymer composition, comprising:
a thermoplastic polyester comprising at least one 1,4:3,6-dianhydrohexitol unit (A), at least one alicyclic diol unit (B) other than the 1,4:3,6-dianhydrohexitol units (A), at least one terephthalic acid unit (C), wherein the (A)/[(A)+(B)] ratio is at least 0.05 and at most 0.75, said polyester not containing any aliphatic non-cyclic diol units or comprising a molar amount of aliphatic non-cyclic diol units, relative to all the monomer units of the polyester, of less than 5%, and the reduced solution viscosity (25° C.; phenol (50% m):ortho-dichlorobenzene (50% m); 5 of polyester) of said polyester is greater than 70 ml/g, and
an additional polymer chosen from aromatic polyesters, aliphatic polyesters, polyester ethers, polyamides, polycarbonates, polyether block amides and polyurethanes.

2. The polymer composition according to claim 1, characterized in that the alicyclic diol (B) is a diol chosen from 1,4-cyclohexanedimethanol, 1,2-cyclohexanedimethanol, 1,3-cyclohexanedimethanol or a mixture of these diols, very preferentially 1,4-cyclohexanedimethanol.

3. The polymer composition according to claim 1, wherein the 1,4:3,6-dianhydrohexitol (A) is isosorbide.

4. The polymer composition according to claim 1 wherein the thermoplastic polyester does not contain any aliphatic non-cyclic diol units, or comprises a molar amount of aliphatic non-cyclic diol units, relative to all the monomer units of the polyester, of less than 1%.

5. The polymer composition according to claim 1, wherein the (3,6-dianhydrohexitol unit (A)+alicyclic diol unit (B) other than the 1,4:3,6-dianhydrohexitol units (A))/(terephthalic acid unit (C)) molar ratio is from 1.05 to 1.5.

6. The polymer composition according to claim 1, wherein it comprises one or more additives and/or a compatiblilizing agent.

7. A process for improving the physical or chemical properties of a polymer, comprising the following steps of:
provision of a polymer chosen from aromatic polyesters, aliphatic polyesters, polyester ethers, polyamides, polycarbonates, polyether block amides and polyurethanes,
blending of said polymer with a thermoplastic polyester comprising at least one 1,4:3,6-dianhydrohexitol unit (A), at least one alicyclic diol unit (B) other than the 1,4:3,6-dianhydrohexitol units (A), at least one terephthalic acid unit (C), wherein the (A)/[(A)+(B)] ratio is at least 0.05 and at most 0.75, said polyester not containing any aliphatic non-cyclic diol units or comprising a molar amount of aliphatic non-cyclic diol units, relative to all the monomer units of the polyester, of less than 5%, and the reduced solution viscosity (25° C.; phenol (50% m):ortho-dichlorobenzene (50% m); 5 g/l of polyester) of said polyester is greater than 70 ml/g, and
recovery of said blend.

8. The process as claimed in claim 7, wherein the blending step is carried out by extrusion or coextrusion techniques.
